(19) United States
(12) Patent Application Publication
(10) Pub. No.: US 2006/0073379 A1
(43) Pub. Date: Apr. 6, 2006

(54) Electric energy storage device and method of manufacturing the same

(76) Inventors: Sung-Min Kim, Yongin-si (KR); Hee-Young Lee, Anyang-si (KR); Yong-Ho Jung, Suwon-si (KR); Heui-Soo Kim, Seoul (KR); Sung-Chul Park, Seoul (KR); Ha-Young Lee, Suwon-si (KR); Eun-Sil Kim, Suwon-si (KR)

Correspondence Address: MAYER, BROWN, ROWE & MAW LLP, 1909 K STREET, N.W., WASHINGTON, DC, 20006, US

(21) Appl. No.: 10/957,649

(22) Filed: Oct. 5, 2004

(51) Int. Cl. H01M 10/00

(52) U.S. Cl. 429/122

(57) ABSTRACT

An the electric energy storage device includes a cylindrical rolling up electrode body, a cathode lead connecting plate, an anode lead connecting plate, a terminal plate, and a container. The rolling up electrode body includes a cathode and an anode leads formed by cathode and anode collectors. The cathode and anode leads are separately extended from one side of the rolling up electrode body. The terminal plate includes a cathode lead connecting plate, an anode lead connecting plate and an insulation combing member for integrally combining the cathode lead connecting plate with the anode lead connecting plate. The container receives the rolling up electrode body. The electric energy storage device may be advantageously connected to another electric energy storage device in serial or parallel. Additionally, the electric energy storage device has some advantages such as reduced volume, enhanced convenience, improved productivity, etc.

### BACKGROUND OF THE INVENTION

1. Field of the Invention

The present invention relates to an electric energy storage device and a method of manufacturing the electric energy storage device. More particularly, the present invention relates to a cylindrical electric energy storage device having terminals extended from one side thereof to thereby have low electric resistance, and a method of manufacturing the cylindrical electric energy storage device.

2. Description of the Related Art

Generally, a terminal connection of an electric energy storage device, for example, a battery and a capacitor, plays an important role to determine resistance, productivity and convenience of the electric energy storage device. Thus, for large electric capacity and low resistance, the terminal connection of the electric energy storage device becomes more important.

The electric energy storage devices generally have various terminal connections in accordance with structures thereof. The electric energy storage devices also have various terminal connections according to electrical characteristics thereof.

FIG. 1 is a cross-sectional view illustrating a conventional electric energy storage device.

Referring to FIG. 1, the conventional electric energy storage device includes a cathode 40 and an anode 50 for storing electric energy, a separator 30, a cathode terminal 45, an anode terminal 55, a container 10 and an electrolyte 20. When the conventional electric energy storage device is an electrolyte condenser or a secondary battery, the electric energy storage device should have the electrolyte 20. An electric double layer capacitor or a hybrid capacitor requires active carbon as active material and a pseudo capacitor demands metal oxide as active material. Because above-mentioned capacitors or electric energy storage devices include a liquid electrolyte, the conventional electric energy storage devices may have disadvantages that cathode and anode terminals are separately extended from both side ends of the electric energy storage devices.

FIG. 2 is a cross-sectional view illustrating a conventional electrolyte condenser.

Referring to FIG. 2, in the conventional electrolyte condenser, lead wires 63 are attached to electrodes 60 by a cold pressing process or a stitching process. After rolling up the electrodes 60, the lead wires 63 are combined with terminals 65 by a riveting process or a welding process. An electrolyte is injected into a container, and then the container is sealed.

To manufacture the electrolyte condenser having large capacity, a plurality of lead wires is generally attached to the electrodes. After the electrodes are wound, the lead wires are attached to the terminals to reduce resistance of the electrolyte condenser. Here, intervals among the lead wires may be properly adjusted to gather the lead wires at predetermined portions of the electrodes. As the number of the lead wires is increased, it is difficult to adjust the intervals among the lead wires.

To overcome the above-mentioned problem, U.S. Pat. No. 6,310,756 discloses an electric energy storage device having a structure for increasing the number of lead wires and for increasing productivity. In the electric energy storage device, after a cathode and an anode are alternately disposed, the cathode and the anode are wound to form a rolling up electrode body. Thus, the cathode is extended from one side of the rolling up electrode body, whereas the cathode is extended from another side of the rolling up electrode body. The extended cathode and anode are combined with terminals by a welding process, an arc spray process or using conductive glue.

However, the above-mentioned electric energy storage device including the terminals extended from both sides thereof may have some inconveniences when several electric energy devices are electrically connected in serial or parallel using cables. That is, when one electric energy storage device is connected to another electric energy storage device, bus bars may be combined with the both sides because the terminals are extended from the both sides. As a result, the electric energy storage devices may have relatively large volume and a connecting process may be also complicated. Additionally, when the terminals are extended from the both sides of the electric energy storage device, a balancing circuit providing a voltage valance to the electric energy storage device is electrically connected to the terminals using wirings. Further, when a pressure valve for maintaining an inner pressure of the electric energy storage device may be attached to the electric energy storage device having the terminals extended from the both sides, an electrolyte may be leaked from the electric energy storage device while the pressure valve is opened because at least half of the electric energy storage device may be disposed over the pressure valve. To prevent leakage of the electrolyte, the electric energy storage device may be used while it lies.

In the above-mentioned electric energy storage device, one terminal is connected to a metal container and the other terminal is connected to a cover of metal. Though the case is electrically insulated from the cover using an anodizing or an insulating member such as polymer, possibility of electrical short between the terminals may still exist. Particularly, in a car that uses a body as a ground, the electrical short may be generated when the case of the electric energy storage device is contacted with the body.

### SUMMARY OF THE INVENTION

The present invention provides an electric energy storage device having terminals extended from one side thereof to have low resistance.

The present invention also provides a method for manufacturing the electric energy storage device.

In accordance with one aspect of the present invention, there is provided an electric energy storage device including a cylindrical rolling up electrode body, a terminal plate and a container for receiving the rolling up electrode body. The cylindrical rolling up electrode body includes a cathode, a separator, an anode, a winding spool, a plurality of cathode leads formed by cathode collectors and a plurality of anode leads formed by anode collectors. The cathode, the separator and the anode are sequentially wound around the winding spool, and the cathode leads and the anode leads are separately extended from one side of the rolling up electrode body. The terminal plate includes a cathode lead connecting plate having a cathode terminal and a cathode lead connecting portion closely contacted with the cathode leads, an anode lead connecting plate having an anode terminal and an anode lead connecting portion closely contacted with the anode leads, and an insulation combing member for integrally combining the cathode lead connecting plate with the anode lead connecting plate. The cathode lead connecting plate is electrically insulated from the anode lead connecting plate. The terminal plate may further includes a sealing plate having a cathode lead connecting portion receiving hole for receiving the cathode lead connecting portion of the cathode lead connecting plate, and an anode lead connecting portion receiving hole for receiving the anode lead connecting portion of the anode lead connecting plate. The sealing plate is combined with the cathode lead connecting plate and the anode lead connecting plate, and the terminal plate and the container is sealed by a seaming process or a welding process. Alternatively, the terminal plate may further include a sealing plate having a cathode lead receiving hole for receiving the cathode lead of the cathode lead connecting plate, and an anode lead receiving hole for receiving the anode lead of the anode lead connecting plate.

In accordance with another aspect of the present invention, there is provided a method of manufacturing an electric energy storage device. In the method, a rolling up electrode body is formed by winding a cathode, a separator and an anode and by partially cutting the cathode and the anode so that cathode leads and anode leads are separately extended from one side of the rolling up electrode body. A terminal plate is formed to include a cathode lead connecting plate having a cathode terminal and a cathode lead connecting portion, and an anode lead connecting plate having an anode terminal and an anode lead connecting portion. The cathode lead connecting plate is electrically insulated from the anode lead connecting plate. After inserting the rolling up electrode body into a container, the terminal plate and the container are sealed while the cathode and the anode lead connecting portions are closely contacted with the cathode and the anode leads, respectively. Then, the cathode and the anode lead connecting portions are combined with the cathode and the anode leads, respectively.

In accordance with the present invention, terminals of the electric energy storage device are extended from one side thereof. Thus, the electric energy storage device may be advantageously connected to another electric energy storage device in serial or parallel comparing to the conventional electric energy storage device having terminals extended from both sides thereof. Additionally, the electric energy storage device having the terminals extended from one side thereof may have some advantages such as a reduced volume, enhanced convenience, improved productivity, etc.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a cross-sectional view illustrating a conventional electric energy storage device;

FIG. 2 is a cross-sectional view illustrating a conventional electrolyte condenser;

FIG. 3A is a plan view illustrating an electric energy storage device in accordance with one embodiment of the present invention;

FIG. 3B is a cross-sectional view illustrating the electric energy storage device taken along a ling of I-I′ in FIG. 3A;

FIG. 4A is a perspective view illustrating a rolling up electrode body 200 in FIG. 3B;

FIG. 4B is a plan view illustrating the rolling up electrode body in FIG. 4A;

FIG. 5A is a plan view illustrating a cathode and an anode lead connecting plates in FIG. 3B;

FIG. 5B is a cross-sectional view illustrating the cathode and the anode lead connecting plates taken along a line of II-II′ in FIG. 5A;

FIG. 5C is a cross-sectional view illustrating a terminal plate including the cathode and the anode lead connecting plates in FIG. 5A;

FIG. 6A is a plan view illustrating a sealing plate in accordance with one embodiment of the present invention;

FIG. 6B is a cross-sectional view illustrating the sealing plate in FIG. 6A;

FIG. 6C is a cross-sectional view illustrating a terminal plate including the sealing plate in FIG. 6B;

FIG. 6D is a cross-sectional view illustrating a container of an electric energy storage device in accordance with one embodiment of the present invention;

FIG. 6E is a partially cut cross-sectional view illustrating combination between the container and a terminal plate in FIG. 6D;

FIG. 7A is a plan view illustrating a sealing plate in accordance with one embodiment of the present invention;

FIG. 7B is a cross-sectional view illustrating a terminal plate including the sealing plate in FIG. 7A;

FIG. 7C is a partially cut cross-sectional view illustrating a combination of a container and the terminal plate in FIG. 7B;

FIG. 8 is a partially cut cross-sectional view illustrating a combination of a terminal plate and a container in accordance with one embodiment of the present invention;

FIG. 9A is a plan view illustrating a plurality of electric energy storage devices connected one another in accordance with one embodiment of the present invention;

FIG. 9B is a cross-sectional view illustrating the electric energy storage devices in FIG. 9A;

FIG. 10 is a cross-sectional view illustrating an electric energy storage device in accordance with one embodiment of the present invention;

FIG. 11 is an enlarged cross-sectional view illustrating a terminal plate in FIG. 10;

FIG. 12A is a cross-sectional view illustrating a sealing plate of an electric energy storage device in accordance with one embodiment of the present invention;

FIG. 12B is an enlarged cross-sectional view illustrating the sealing plate of the electric energy storage device in FIG. 12A;

FIG. 12C is an enlarged cross-sectional view illustrating lead connecting plates of the electric energy storage device in FIG. 12A;

FIG. 12D is an enlarged cross-sectional view illustrating a terminal plate including the sealing plate in FIG. 12A and the lead connecting plates in FIG. 12C;

FIG. 13 is a flow chart illustrating a method of manufacturing an electric energy storage device in accordance with one embodiment of the present invention; and

FIG. 14 is a cross-sectional view illustrating a method of manufacturing a rolling up electrode body in accordance with one embodiment of the present invention.

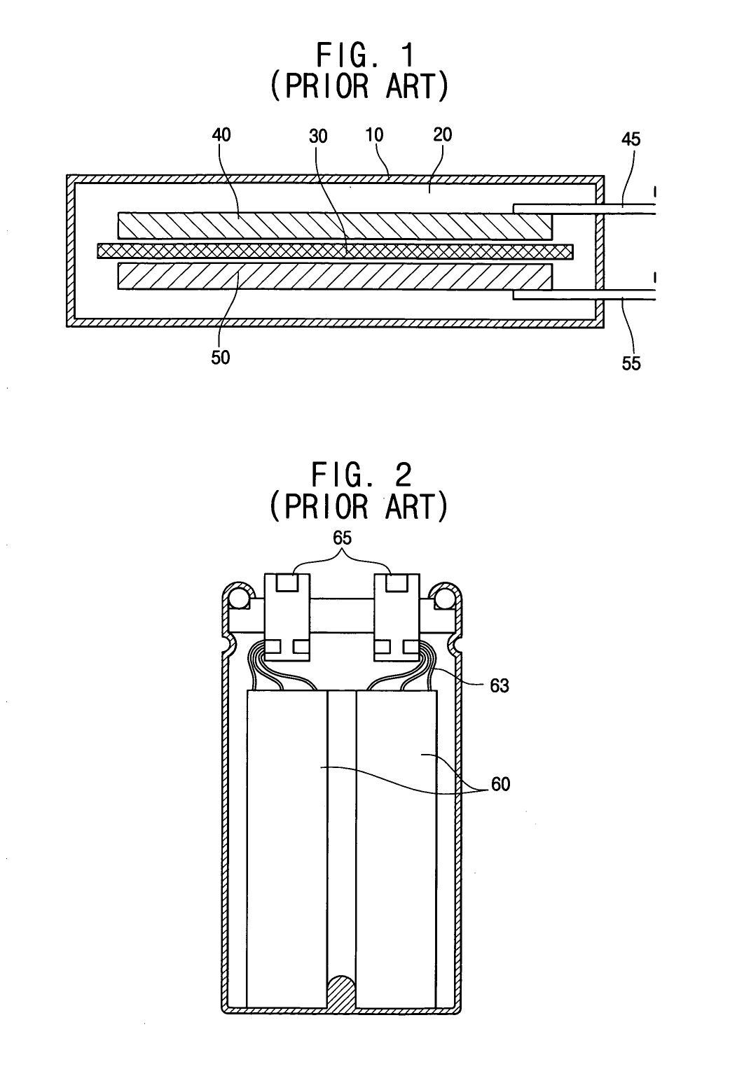

### DESCRIPTION OF THE PREFERRED EMBODIMENTS

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like reference numerals refer to similar or identical elements throughout.

An electric energy storage device of an exemplary embodiment of the present invention includes lead connecting plates having lead connecting portions and a rolling up electrode body having leads. The leads are connected to the lead connecting portions by a laser welding process. The electric energy storage device further includes a terminal plate and a container. The terminal plate and the container are sealed using an elastic ring interposed between the terminal plate and the container. The electric energy storage device of the present invention may include various elements, for example, a sealing plate, a combination structure of the container and the terminal plate, etc. However, the electric energy storage devices of exemplary embodiment of the present invention may include substantially identical rolling up electrode bodies.

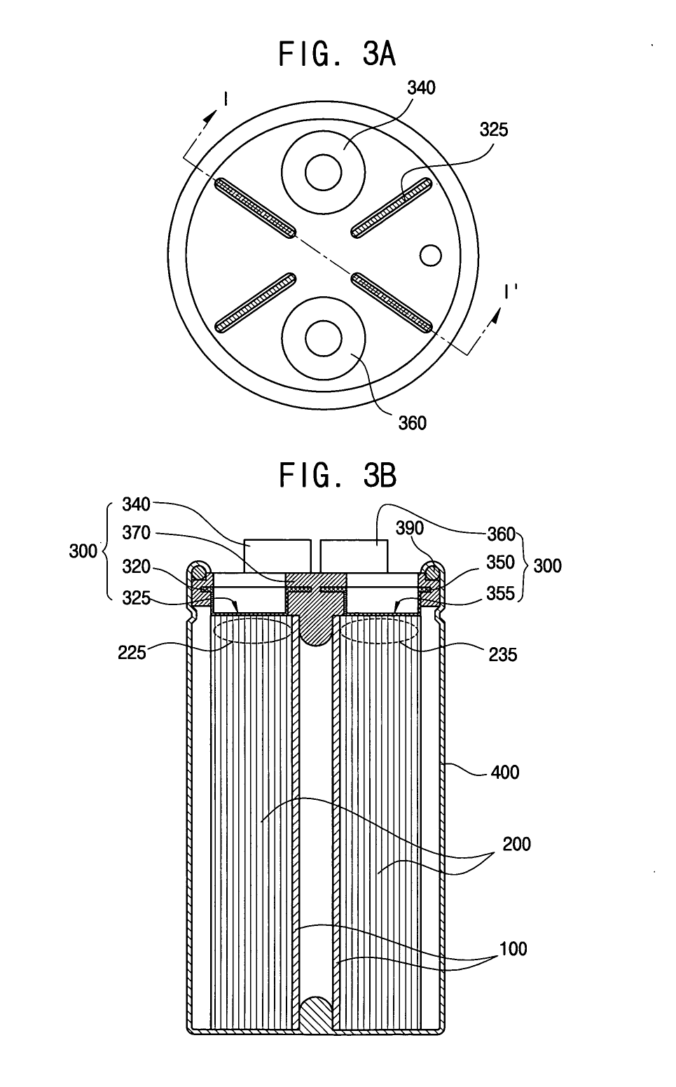

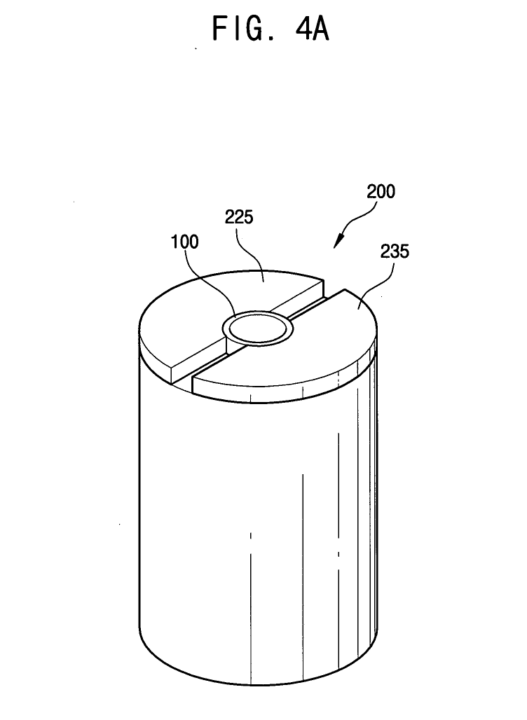

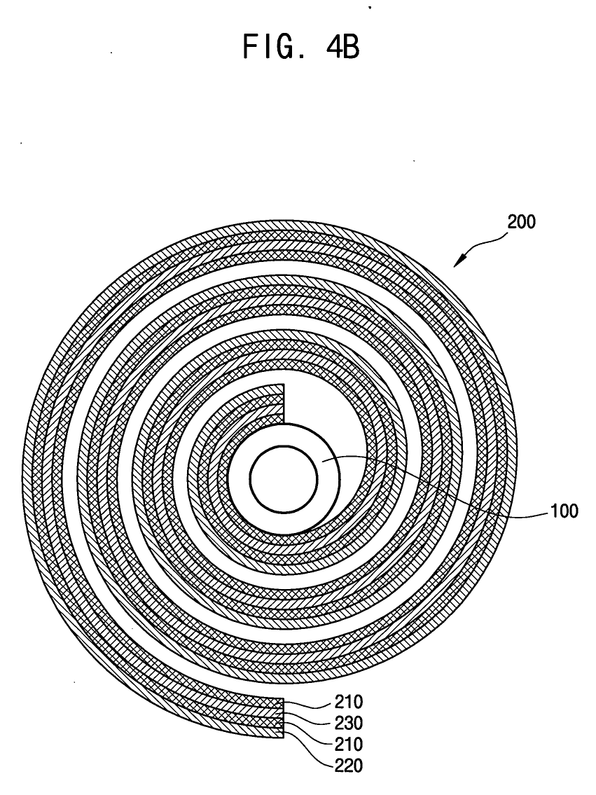

FIG. 3A is a plan view illustrating an electric energy storage device in accordance with one embodiment of the present invention, and FIG. 3B is a cross-sectional view illustrating the electric energy storage device taken along a line of I-I′ in FIG. 3A.

Referring to FIGS. 3A and 3B, the electric energy storage device includes a rolling up electrode body 200, a terminal plate 300, and a container 400.

FIG. 4A is a perspective view illustrating the rolling up electrode body 200 in FIG. 3B, and FIG. 4B is a plan view illustrating the rolling up electrode body 200 in FIG. 4A.

Referring to FIGS. 4A and 4B, the rolling up electrode body 200 includes a cathode 220, a separator 210 and an anode 230. The cathode 220, the separator 210 and the anode 230 are sequentially wound centering around a winding spool 100.

The rolling up electrode body 200 further includes a cathode lead 225 and an anode lead 235. The cathode lead 225 and the anode lead 235 are formed from a cathode current collector and an anode current collector, respectively. The cathode lead 225 is extended from an end portion of the rolling up electrode body 200, and the anode lead 235 is also extended from the end portion of the rolling up electrode body 200. Here, the cathode lead 225 and the anode lead 235 are separated from each other. The rolling up electrode body 200 generally has a cylindrical structure.

Because the cathode and anode leads 225 and 235 are extended from one end portion of the rolling up electrode body 200, several electric energy storage devices including the cathode and anode leads 225 and 235 may be easily connected one another in serial or parallel. Additionally, a cable may be advantageously connected to the cathode and anode leads 225 and 235. When the cathode and anode leads 225 and 235 are formed at one end portion of the rolling up electrode body 200, a bus bar may be easily installed in a case to electrically connect to the electric energy storage devices after the electric energy storage devices are inserted into the case. Also, the case may have a reduced volume because the bus bar may be positioned at one end portion of the vase. When a balancing circuit may be employed for electrical connection between the electric energy storage devices in parallel, the balancing circuit may be conveniently fixed to the bus bar using a screw.

Referring now to FIGS. 3A and 3B, the electric energy storage device includes the terminal plate 300 that has a cathode lead connecting plate 320 and an anode lead connecting plate 350. A cathode terminal 340 is formed on the cathode lead connecting plate 320, and an anode terminal 360 is formed on the anode lead connecting plate 360. The cathode lead connecting plate 320 and the anode lead connecting plate 350 are integrally formed by interposing an insulation combing member 370 therebetween.

In one embodiment of the present invention, after a cathode and an anode lead connecting portions 325 and 355 of the cathode and anode lead connecting plates 320 and 350 are respectively attached to the cathode and anode leads 225 and 235 by a laser welding process, an elastic ring 390 is interposed between the container 400 and the terminal plate 300 to seal the container 400 and the terminal plate 300. For example, the elastic ring 390 includes elastic material such as rubber.

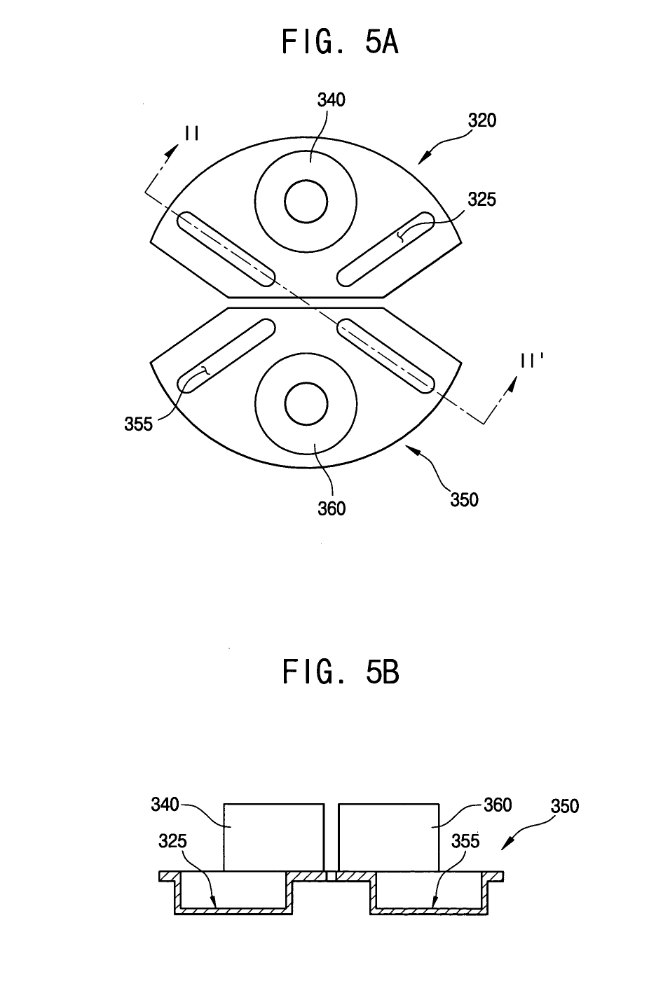

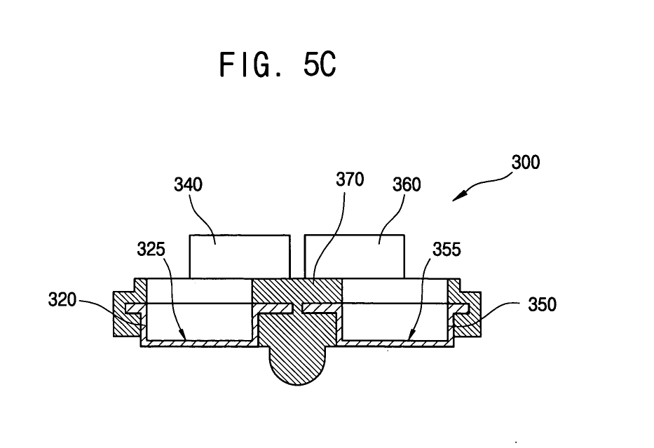

FIG. 5A is a plan view illustrating the cathode and the anode lead connecting plates 320 and 350 in FIG. 3B, and FIG. 5B is a cross-sectional view illustrating the cathode and the anode lead connecting plates 320 and 350 taken along a line of II-II′ in FIG. 5A.

Referring to FIGS. 5A and 5B, the cathode terminal 340 and the anode terminal 350 are integrally formed with the cathode lead connecting plate 320 and the anode lead connecting plate 340, respectively. The cathode terminal 340 and the anode terminal 350 may be integrally formed on the cathode lead connecting plate 320 and the anode lead connecting plate 340 by a die casting process, a casting process, etc. Alternatively, the cathode terminal 340 and the anode terminal 350 may be respectively coupled to the cathode lead connecting plate 320 and the anode lead connecting plate 340 by a welding process, a soldering process, a blazing process, etc.

The cathode lead connecting plate 320 advantageously includes material substantially identical to that of a collector for the cathode 220, and also the anode lead connecting plate 350 preferably includes material substantially identical to that of a collector for the anode 230. For example, the cathode lead connecting plate 320 and the collector for the cathode 220 are formed using metal such as aluminum (Al) or aluminum alloy. Additionally, the anode connecting plate 350 and the collector for the anode 230 may be formed using aluminum or aluminum alloy

When the electric energy storage device includes liquid electrolyte, the cathode and the anode lead connecting plates 320 and 350 have electrochemical stabilities. The collectors for the cathode 220 and the anode 230 generally have electrochemical stabilities with respect to the liquid electrolyte of the electric energy storage device. When the cathode lead connecting plate 320 connected to the cathode 220 is preferably formed using material substantially identical to that of the collector for the cathode 220 and the anode lead connecting plate 350 connected to the anode 230 is formed using material substantially identical to that of the collector for the cathode 220, the electric energy storage device may have improved electrical stability. In addition, the cathode and the anode lead connecting plates 320 and 350 may be easily welded to the cathode 220 and the anode 230, respectively. Because collectors for a cathode and an anode of an electrolytic condenser or an electric double layer capacitor are generally formed using aluminum, a cathode lead connecting plate and an anode lead connecting plate are preferably formed using aluminum.

Because a collector for a cathode a lithium secondary battery is generally formed using aluminum and a collector for an anode of the lithium secondary battery is generally formed using copper (Cu), a cathode lead connecting plate the lithium secondary battery is advantageously formed using aluminum and an anode lead connecting plate of the lithium secondary battery is preferably formed using aluminum. As for material of the cathode and the anode lead connecting plates, it is very important that the cathode and the anode connecting plates have electrochemical stabilities. Thus, the cathode and the anode lead connecting plates may be formed using proper material considering the electrochemical stability of the electric energy storage device.

When the cathode and anode leads 225 and 235 of the rolling up electrode body 200 are respectively welded to the cathode and anode lead connecting plates 320 and 350 by a laser welding process, the cathode and the anode lead connecting plates 320 and 350 are preferably formed using aluminum having relatively high purity because the collectors for the cathode 220 and the anode 230 are formed using aluminum. Here, the cathode and anode terminals 340 and 360 are formed using material substantially different from that of the cathode and the anode lead connecting plates 320 and 350. Though aluminum having relatively high purity may be advantageously used for the cathode and anode terminals 340 and 360 in the laser welding process, aluminum of relatively high purity may not have good mechanical strength and mechanical workability. Thus, the bus bar or the cable may not be efficiently coupled to the cathode and anode terminals 340 and 360. Additionally, the cathode and anode terminals 340 and 360 do not contact the electrolyte because the cathode and anode terminals 340 and 360 are located on outer faces of the cathode and the anode lead connecting plates 320 and 350. Therefore, the cathode and anode terminals 340 and 360 are preferably formed using material having mechanical and electrical characteristics rather than electrochemical stabilities. Thus, the cathode and the anode terminals 340 and 360 are respectively coupled to the cathode and the anode lead connecting plates 320 and 350 by a welding process, a soldering process, a blazing process, etc. Here, the cathode and the anode terminals 340 and 360 include copper alloy or aluminum alloy that has good mechanical characteristics and electrical conductivity.

The cathode and the anode lead connecting plates 320 and 350 include a cathode and an anode lead connecting portions 325 and 355, respectively. The cathode and the anode lead connecting portions 325 and 355 are electrically connected to the cathode and the anode leads 225 and 235 of the rolling up electrode body 200. The lead connecting portions 325 and 355 are closely contacted with the cathode and the anode leads 225 and 235 of the rolling up electrode body 200. Additionally, the cathode and the anode lead connecting portions 325 and 355 are partially extended toward the rolling up electrode body 200 to thereby advantageously inject an electrolyte into the separator 210. However, the cathode and the anode lead connecting portions 325 and 355 may not be extended when the cathode and the anode lead connecting plates 320 and 350 are connected to the cathode and the anode leads 225 and 235 of the rolling up electrode body 200.

FIG. 5C is a cross-sectional view illustrating the terminal plate 300 including the cathode and the anode lead connecting plates 320 and 350 in FIG. 5A.

Referring to FIGS. 5A and 5C, the terminal plate 300 includes the cathode lead connecting plate 320, the anode connecting plate 350, and the insulation combining member 370. The cathode lead connecting plate 320 and the anode connecting plate 350 are integrally formed by the insulation combing member 370. The terminal plate 300 substantially may have a disk shape.

The cathode lead connecting plate 320 and the anode connecting plate 350 are integrally molded by a resin molding process so that the cathode lead connecting plate 320 and the anode lead connecting plate 350 are integrally combined with each other by interposing the insulation combing member 370. A central protruding portion of the insulation combining member 370 is inserted into the winding spool 100 so that the cathode and the anode lead connecting portions 325 and 355 are precisely and closely contacted with the cathode leads 225 and 235 of the rolling up electrode body 200.

When the cathode and the anode lead connecting portions 325 and 355 are respectively welded to the cathode and the anode lead connecting plates 320 and 350 by the laser welding process, upper and lower faces of the cathode and the anode lead connecting portions 325 and 355 are exposed and the rolling up electrode body 200 is inserted into the container 400. Then, using a central protruding portion of the terminal plate 300 and a central protruding portion of the container 400, the terminal plate 400 and the container 400 are combined to each other while the cathode and the anode leads 225 and 235 of the rolling up electrode body 200 are closely contacted with the cathode and the anode lead connecting portions 325 and 355 of the terminal plate 300. Thus, the rolling up electrode body 200 is fixed between the terminal plate 300 and the container 400. Laser is irradiated onto the upper faces of the cathode and anode lead connecting portions 325 and 355 to thereby combine the cathode and anode leads 225 and 235 of the rolling up electrode body 200 with the lower faces of the cathode and the anode lead connecting portions 325 and 355, respectively. Therefore, a plurality of cathode and anode leads 225 and 235 of a rolling up electrode body 200 may be easily attached to a terminal plate, and also the cathode and the anode leads may not easily separated from the terminal plate 300 by vibration or impact from outside.

The insulation combining member 370 is formed using material having durability relative to chemicals. For example, the insulation combining member 370 is formed using polyethylene (PE), polypropylene (PP), polyphenylene sulfide (PPS), polyether ether ketone (PEEK), polytetrafluoro ethylene (PTFE), etc. The insulation combining member 370 may be advantageously formed using PPS and PEEK because PPS and PEEK additionally have good mechanical strength and thermal resistance.

The electric energy storage device includes the container 400 having a cylindrical structure of which one face is opened for receiving the rolling up electrode body 200. The container 400 may be formed using material such as aluminum, stainless steel, tin-plated steel, etc. Alternatively, the container 400 may be formed using resin such as polyethylene (PE), polypropylene (PP), polyphenylene sulfide (PPS), polyether ether ketone (PEEK), polytetrafluoro ethylene (PTFE), etc. In the present invention, the container 400 may be formed using proper material in accordance with kinds of the electrolyte.

When an electric energy storage device includes an aqueous electrolyte, the container 400 is formed using PE or PP considering the durability relative to chemicals because the PE and the PP have resistance relative to acid and base. Additionally, the container 400 may be formed using stain less steel considering the reason described above.

When the electric energy storage device including an organic electrolyte, the container 400 may be formed using aluminum, PE or PP because PE and PP have good resistance relative to chemicals and aluminum has a light weight and good workability, a relatively low price, and resistance relative to chemicals.

An electric energy storage device of one embodiment of the present invention may include a rolling up electrode body having a cathode lead and an anode lead, a cathode lead connecting plate having a cathode lead connecting portion, an anode lead connecting plate having an anode lead connecting portion, a terminal plate having a sealing plate and a container. The cathode and the anode lead connecting portions are connected to the cathode and the anode leads by a laser welding process, respectively. The container and the terminal plate are sealed by a seaming process.

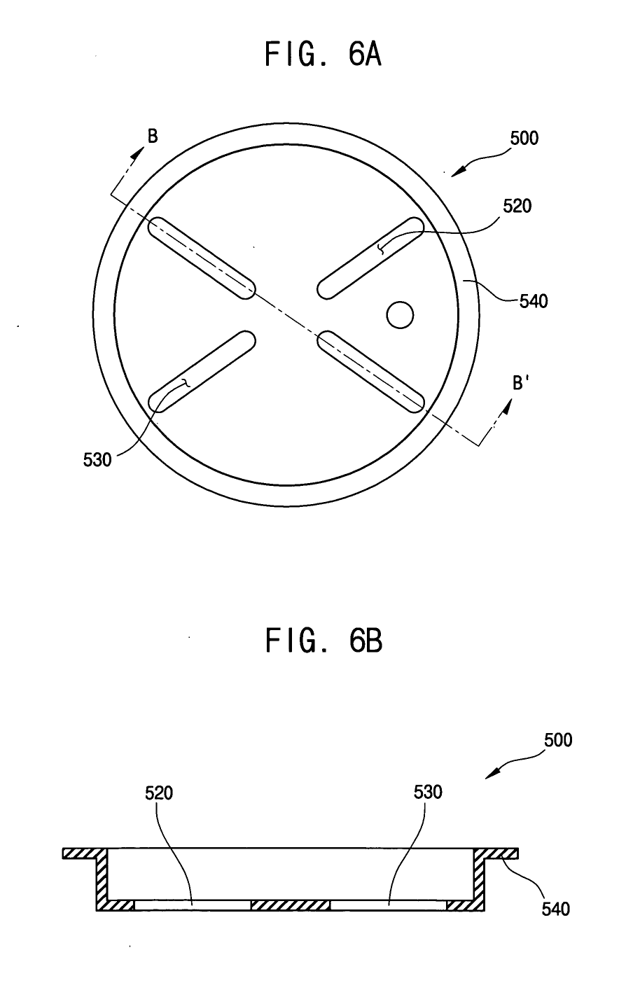

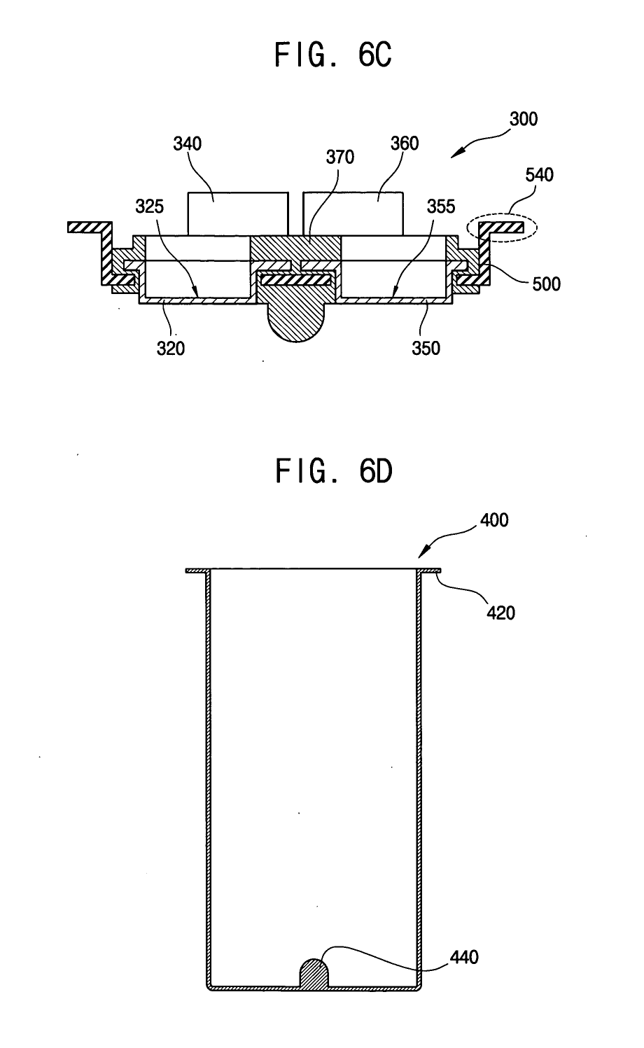

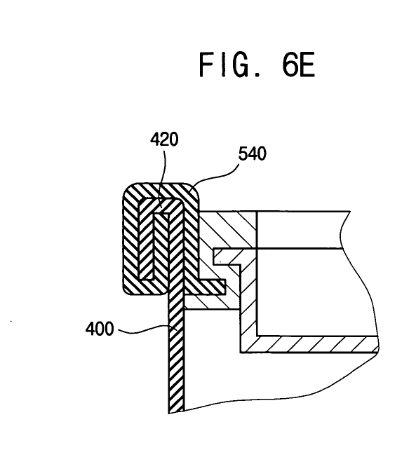

FIG. 6A is a plan view illustrating a sealing plate in accordance with one embodiment of the present invention, FIG. 6B is a cross-sectional view illustrating the sealing plate in FIG. 6A and FIG. 6C is a cross-sectional view illustrating a terminal plate including the sealing plate in FIG. 6B.

Referring to FIGS. 6A to 6C, the cathode lead connecting portion 325 and the anode lead connecting portion 355 (see FIGS. 5A and 5B) are inserted into a cathode lead connecting portion receiving hole 520 and an anode lead connecting portion containing hole 530 of a sealing plate 500, respectively. Then, the sealing plate 500 is integrally combined with the cathode and the anode lead connecting plates 320 and 350 by interposing an insulation combining member such as resin as shown in FIG. 6C. Here, the sealing plate 500 is electrically insulated from the cathode and the anode lead connecting plates 320 and 350 by the insulation combining member. Upper and bottom faces of the cathode and the anode lead connecting portions 323 and 355 are exposed considering a laser welding process for combining the cathode and the anode leads 225 and 235 of the rolling up electrode body 200 with the cathode and the anode lead connecting portions 323 and 355 of the cathode and the anode lead connecting plates 320 and 350.

FIG. 6D is a cross-sectional view illustrating a container of an electric energy storage device in accordance with one embodiment of the present invention, FIG. 6E is a partially cut cross-sectional view illustrating combination between the container and a terminal plate in FIG. 6D.

Referring to FIGS. 6C to 6E, when a terminal plate and a container 400 are sealed by a seaming process, the terminal plate may be formed using aluminum or tin-plated steel. The terminal plate has a flange 540 coated with resin or rubber. The container 400 also has a flange 420 corresponding to the flange 540 of the terminal plate. The rolling up electrode body 200 is inserted into the container 400 having the flange 420. The terminal plate and the container 400 are combined with each other using a central protruding portion of the terminal plate and a bottom protruding portion 440 of the container 400 while the cathode and the anode leads 225 and 235 of the rolling up electrode body 200 are closely coupled to the cathode and the anode lead connecting portions 325 and 355 of a cathode and an anode lead connecting plates 320 and 350. The flange 540 of the terminal plate is combined with the flange 420 of the container 400 by the seaming process to fix the terminal plate to the container 400. Then, laser is irradiated onto upper faces of the cathode and the anode lead connecting portions 325 and 355 so that the cathode and the anode leads 225 and 235 of the rolling up electrode body 200 are attached to the cathode and the anode lead connecting portions 325 and 355, respectively.

In an electric energy storage device according to one embodiment of the present invention, the electric energy storage device includes a rolling up electrode body having a cathode lead and an anode lead, a cathode lead connecting plate having a cathode lead connecting portion, an anode lead connecting plate having an anode lead connecting portion, a terminal plate having a sealing plate and a container. The cathode and the anode lead connecting portions are connected to the cathode and the anode leads by a laser welding process, respectively. The container and the terminal plate are combined with each other sealed by a welding process.

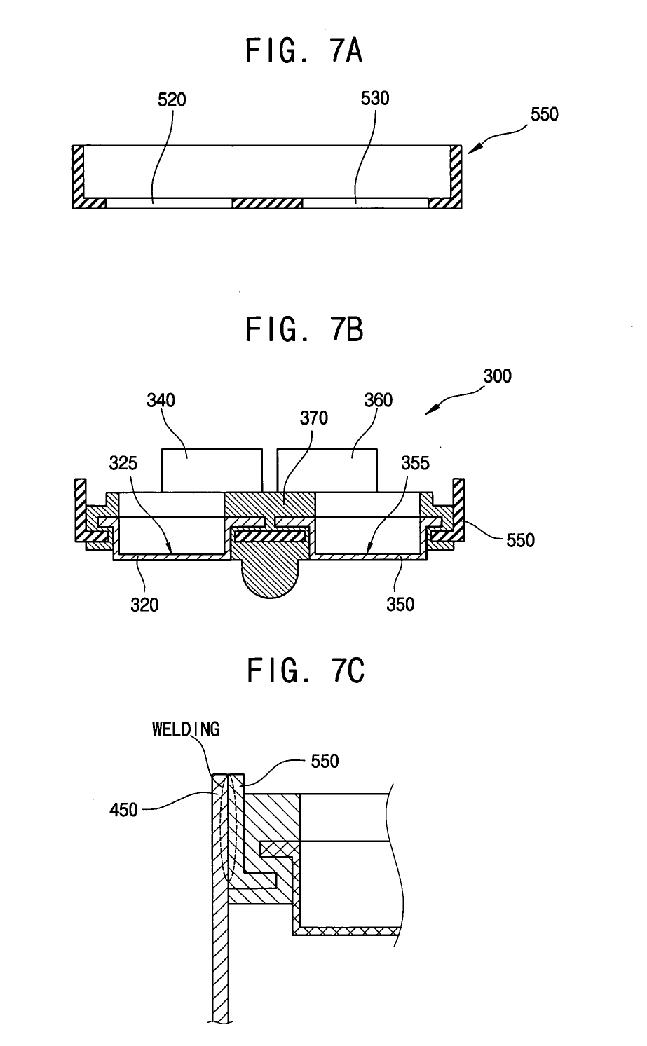

FIG. 7A is a plan view illustrating a sealing plate in accordance with one embodiment of the present invention, FIG. 7B is a cross-sectional view illustrating a terminal plate including the sealing plate in FIG. 7A, and FIG. 7C is a partially cut cross-sectional view illustrating a combination of a container and the terminal plate in FIG. 7B.

Referring to FIGS. 7A to 7C, a sealing plate 550 of the present embodiment does not include a flange, and a container 450 of the present embodiment also does not include a flange. A terminal plate 300 and the container 450 have elements substantially identical to those described with reference to FIGS. 6C to 6E except the flanges.

The terminal plate 300 including the sealing plate 550 is combined with the container 450 by welding outer lateral portions of the sealing plate 550 with inner lateral portions of the container 450 as shown in FIG. 7C. Accordingly, upper portions of the container 450 are attached to the sealing plate 550 by a welding process.

In one embodiment of the present invention, an electric energy storage device includes a rolling up electrode body having a cathode lead and an anode lead, a cathode lead connecting plate having a cathode lead connecting portion, an anode lead connecting plate having an anode lead connecting portion, a terminal plate and a container. The cathode and the anode lead connecting portions are combined with the cathode and the anode leads by a laser welding process. The terminal plate and the container may be formed using thermoplastic resin such as polyethylene resin, polypropylene resin, nylon resin, polyacetal resin, vinyl chloride resin, polystyrene resin, acrylonitrile butadiene styrene copolymer (ABS) resin, etc. The terminal plate and the container are combined with each other by a welding process.

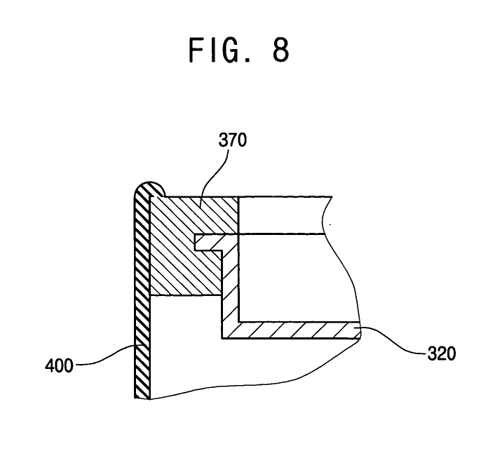

FIG. 8 is a partially cut cross-sectional view illustrating a combination of a terminal plate and a container in accordance with one embodiment of the present invention.

Referring to FIG. 8, an insulation combining member 370 of the present embodiment may be formed using thermoplastic resin such as polyethylene resin or polypropylene resin. Also, the container 400 may be formed using thermoplastic resin. The insulation combining member 370 and the container 400 are combined with each other by applying heat to the container 400 and the insulation combining member 370. A cathode lead connecting portion of a cathode lead connecting plate 320 and an anode lead connecting portion of an anode lead connecting plate are respectively attached to a cathode lead and an anode lead of a rolling up electrode body by a laser welding process.

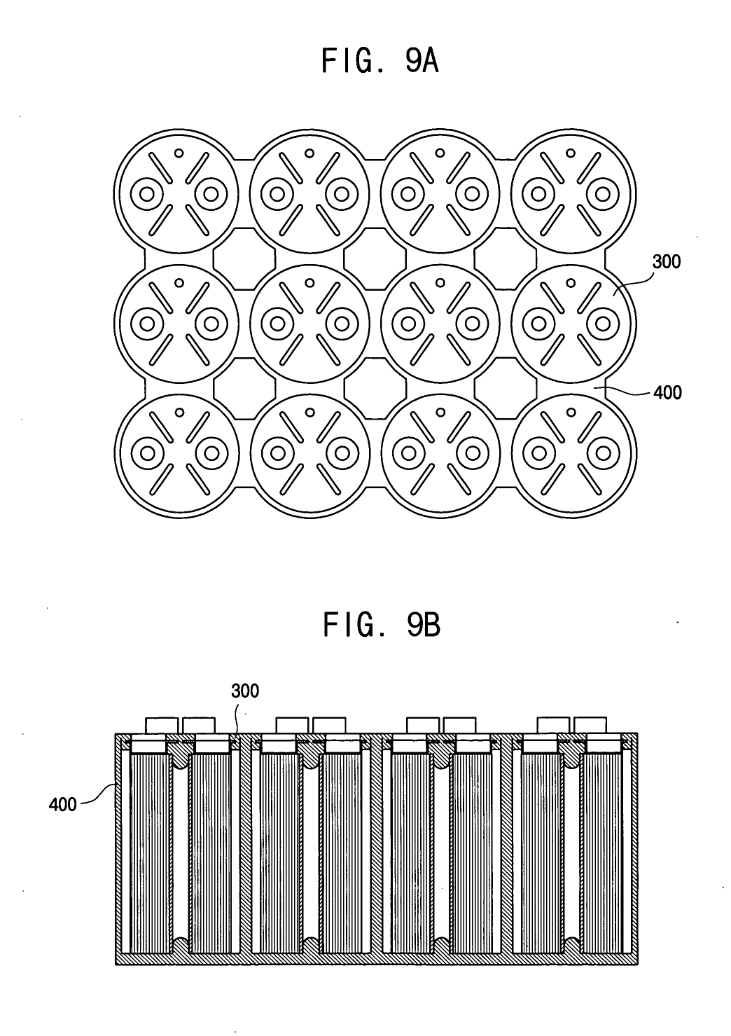

FIG. 9A is a plan view illustrating a plurality of electric energy storage devices connected one another in accordance with one embodiment of the present invention, and FIG. 9B is a cross-sectional view illustrating the electric energy storage devices in FIG. 9A.

As shown in FIGS. 9A and 9B, when electric energy storage devices including containers 400 and terminal plates 300 are electrically connected to one another in serial or parallel, the containers 400 may be formed using thermoplastic resin without an additional case for receiving all of the electric energy storage devices, thereby efficiently connecting the electric energy storage devices. When the electric energy storage devices respectively include rolling up electrode bodies having cathode leads and anode leads and terminal plates having cathode lead connecting portions and anode lead connecting portions, metal is advantageously coated on the cathode and anode leads of the rolling up electrode bodies by a plasma spray process or an arc spray process so as to enhance welding efficiency between the cathode and anode leads and the cathode lead connecting portions. In particular, when the electric energy storage device is a film type condenser, the plasma spray process or the arc spray process may be effectively employed for coating metal on cathode and anode leads thereof. Alternatively, conductive glue may be used to attach the cathode and anode lead connecting portions to the cathode and anode leads.

In an electric energy storage device in accordance with one embodiment of the present invention, the electric energy storage device includes a cathode lead connecting plate having a cathode lead connecting portion, an anode lead connecting plate having an anode lead connecting portion, a rolling up electrode body having a cathode lead and an anode lead, a terminal plate, a container and an elastic ring. The cathode and anode leads are combined with the cathode and anode lead connecting plates using conductive glue. The terminal plate and the container are sealed by interposing the elastic ring therebetween.

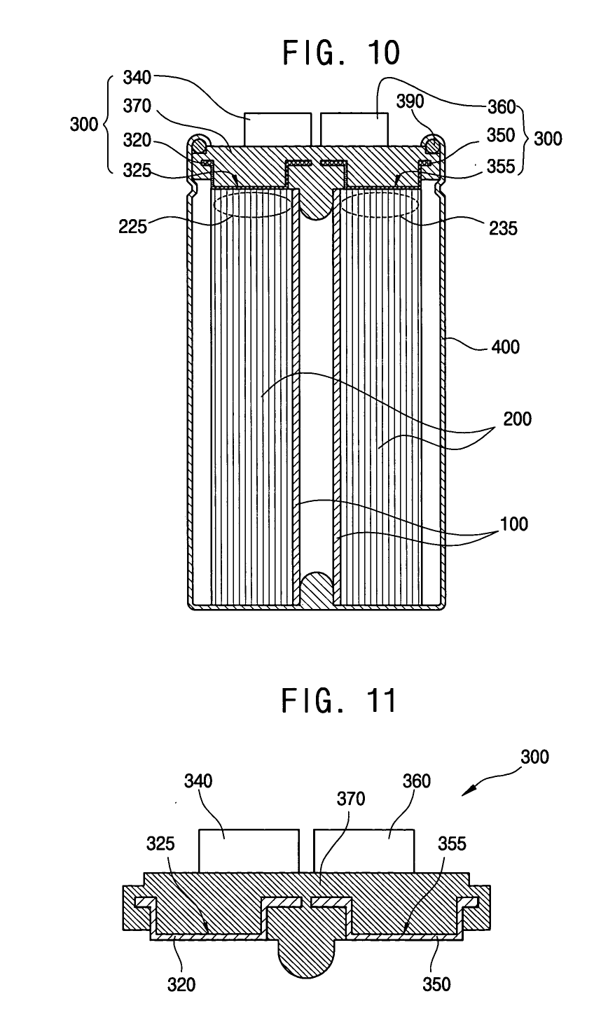

FIG. 10 is a cross-sectional view illustrating an electric energy storage device in accordance with one embodiment of the present invention, and FIG. 11 is an enlarged cross-sectional view illustrating a terminal plate in FIG. 10.

Referring to FIG. 10, an electric energy storage device of the present embodiment includes a rolling electrode body 200 having a cathode lead 225 and an anode lead 235, a cathode lead connecting plate 320 having a cathode lead connecting portion 325, an anode lead connecting plate 350 having an anode lead connecting portion 355, a container 400, a terminal plate 300 and an elastic ring 390.

The cathode and the anode lead connecting portions 325 and 355 are respectively attached to the cathode and anode leads 225 and 235 using conductive glue without a laser welding process. The elastic ring 390 is interposed between the container 400 and the terminal plate 300 to thereby seal the container 400 and the terminal plate 300.

Referring to FIG. 11, when the terminal plate 300 includes an insulation combing member 370 of resin as described above, bottom faces of the cathode and anode lead connecting portions 325 and 355 are exposed only to thereby attach the cathode and anode lead connecting portions 325 and 355 to the cathode and anode leads 225 and 235 using the conductive glue. That is, the conductive glue is interposed among the cathode and anode lead connecting portions 325 and 355 and the cathode and anode leads 225 and 235.

After inserting the rolling up electrode body 200 into the container 400, the cathode and anode leads 225 and 235 are coated with the conductive glue. The terminal plate 300 and the container 400 are sealed using the elastic ring 390 while the cathode and anode lead connecting portions 325 and 355 of the terminal plate 300 are closely contacted with the cathode and anode leads 225 and 235 of the rolling up electrode body 200. Then, the conductive glue is dried.

In an electric energy storage device in accordance with one embodiment of the present invention, the electric energy storage device includes a terminal plate having a sealing plate, a cathode lead connecting plate and an anode lead connecting plate. The sealing plate is disposed on the cathode and anode lead connecting plates. The cathode and anode lead connecting plates have a cathode and an anode lead connecting portions, respectively. The cathode and anode lead connecting portions are combined with a cathode lead and an anode lead of a rolling up electrode body by a laser welding process. Additionally, the terminal plate is sealed with a container by a seaming process.

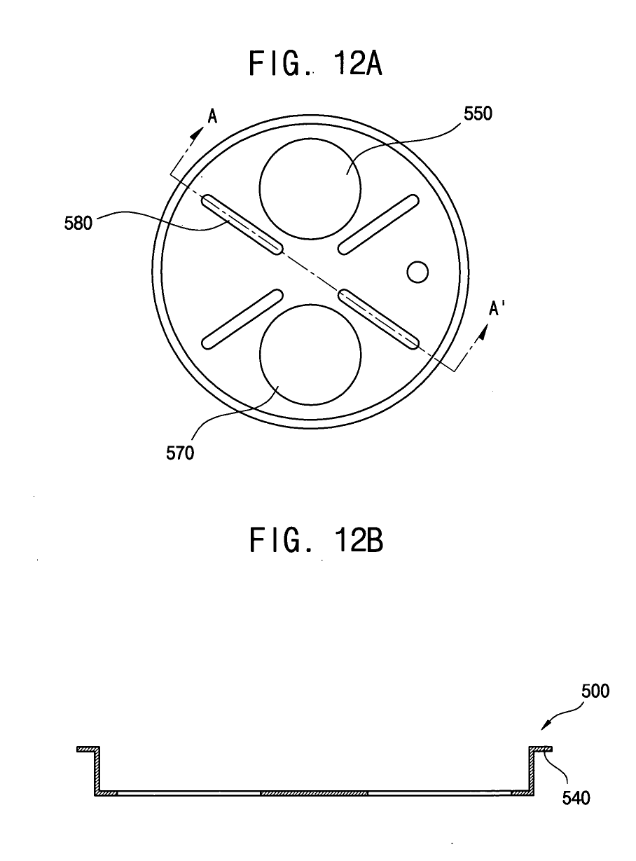

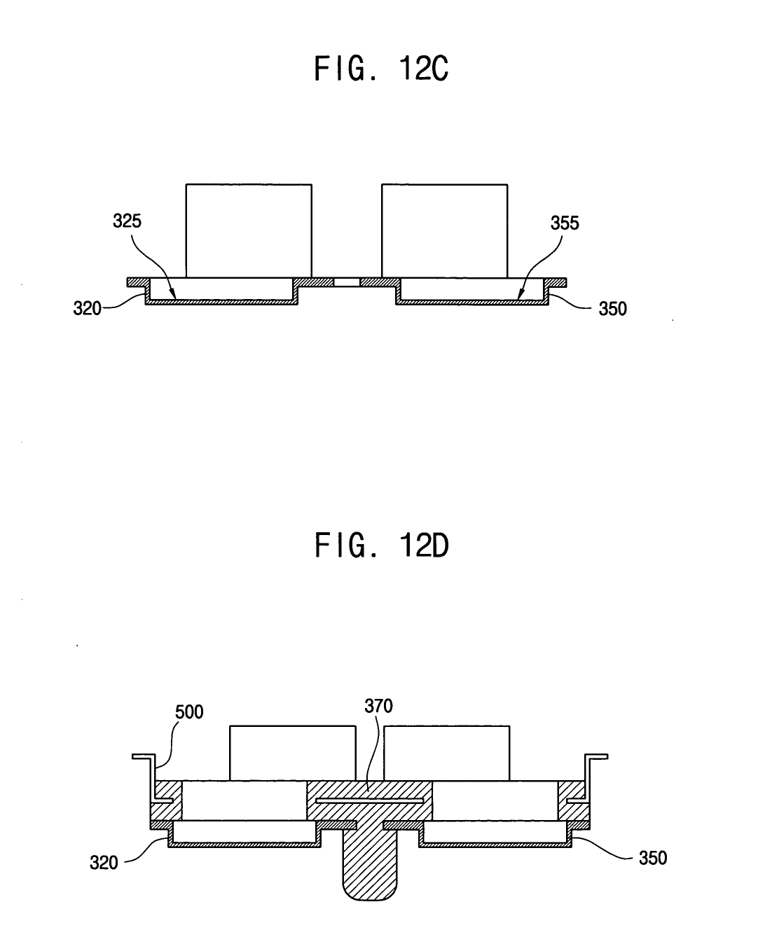

FIG. 12A is a cross-sectional view illustrating a sealing plate of an electric energy storage device in accordance with one embodiment of the present invention, and FIG. 12B is an enlarged cross-sectional view illustrating the sealing plate of the electric energy storage device in FIG. 12A. Also, FIG. 12C is an enlarged cross-sectional view illustrating lead connecting plates of the electric energy storage device in FIG. 12A, and FIG. 12D is an enlarged cross-sectional view illustrating a terminal plate including the sealing plate in FIG. 12A and the lead connecting plates in FIG. 12C.

Referring to FIGS. 12A to 12D, the electric energy storage device includes a sealing plate 500 having a cathode lead receiving hole 550, an anode lead receiving hole 570, and slits 580 for a laser welding process. The electric energy storage device further includes a cathode lead connecting plate 320 having a cathode lead connecting portion 325 and an anode lead connecting plate 350 having an anode lead connecting portion 355.

The cathode and anode lead connecting plates 320 and 350 are positioned beneath the sealing plate 500. The cathode and anode lead connecting portions 325 and 355 are inserted into the cathode and anode lead receiving holes 550 and 570, respectively. When the cathode and anode lead connecting portions 325 and 355 are attached to a cathode lead and an anode lead of a rolling up electrode body by the laser welding process, laser is irradiated onto the cathode and anode lead connecting portions 325 and 355 through the slits 580. Thus, the slits 580 may not be formed when the cathode and anode lead connecting portions 325 and 355 are attached to the cathode and anode leads using conductive glue.

In a terminal plate of the electric energy storage device, the cathode and anode lead connecting portions 325 and 355 of the cathode and anode lead connecting plates 320 and 350 are inserted into the cathode and anode lead receiving holes 550 and 570 of the sealing plate 500, respectively. Then, the sealing plate 500 is combined with the cathode and anode lead connecting plates 320 and 350 by a molding process while an insulation combining member 370 is interposed among the sealing plate 500 and the cathode and anode lead connecting plates 320 and 350. The cathode and anode leads of the rolling up electrode body may be combined with the cathode and anode lead connecting portions 325 and 355 by a laser welding process or using conductive glue.

An electric energy storage device of the present invention may include an aqueous electrolyte or an organic electrolyte inserted into a container due to occasion demands. When a pressure valve for maintaining an inner pressure of the electric energy storage device by a predetermined value is additionally installed to the electric energy storage device, an electrolyte of the electric energy storage device may not be leaked when the pressure valve is opened because the electric energy storage device has a cathode terminal and an anode terminal extended along one direction.

Hereinafter, a method of manufacturing an electric energy storage device of the present invention will be illustrated in detail.

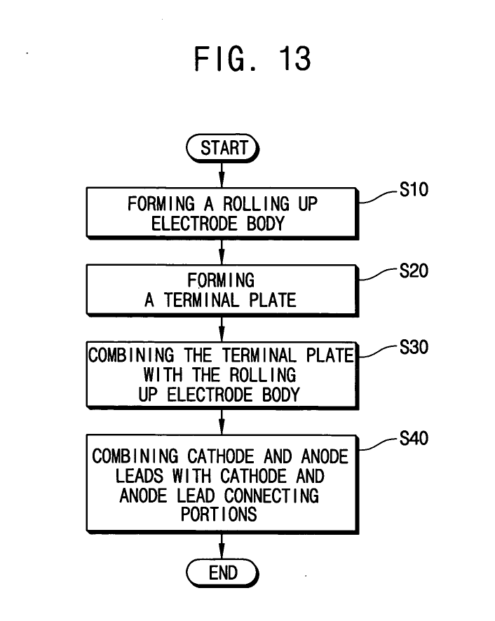

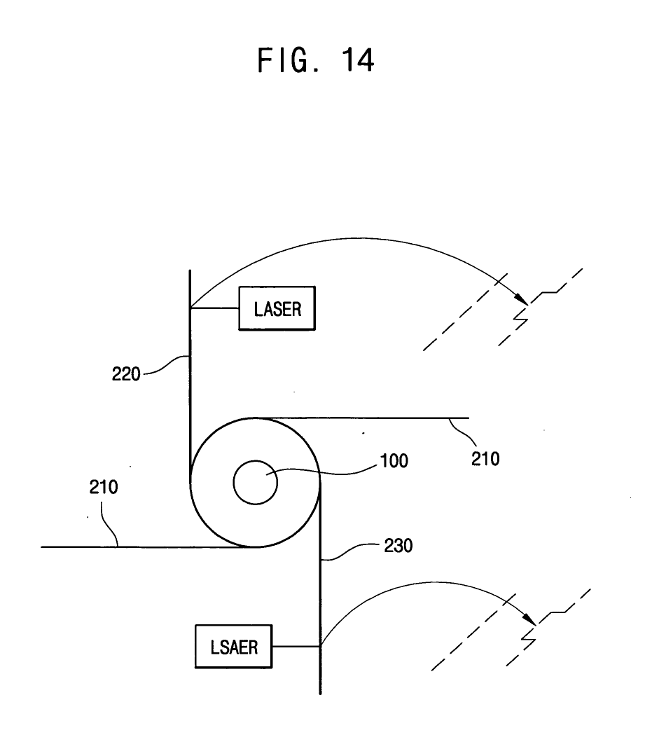

FIG. 13 is a flow chart illustrating a method of manufacturing an electric energy storage device in accordance with one embodiment of the present invention, and FIG. 14 is a cross-sectional view illustrating a method of manufacturing a rolling up electrode body in accordance with one embodiment of the present invention.

Referring to FIG. 13, to manufacture the electric energy storage device, after a rolling up electrode body is formed in step S10, a terminal plate is formed in step S20. As shown in FIG. 14, a cathode 220 and an anode 230 are sequentially wound centering around a winding spool 100 with a separator 210 interposed between the winding spool 100 and the cathode 220 and between the cathode 220 and the anode 230. Thus, the rolling up electrode body having a cylindrical structure is formed. A plurality of cathode leads is extended from one side of the rolling up electrode body and a plurality of anode leads is also extended from one side of the rolling up electrode body. Here, the cathode leads are separated from the anode leads. In winding the cathode 220, the anode 230 and the separator 210, portions of the rolling up electrode body where cathode and anode leads are formed are cut using laser so that the cathode and anode leads are separately extended from one side of the rolling up electrode body.

The terminal plate is independently formed relative to the rolling up electrode body. To manufacture the terminal plate, a cathode and an anode lead connecting plates including a cathode and an anode terminals and a cathode and an anode lead connecting portions are integrally formed by a die casting process or a casting process. Alternatively, after a cathode and an anode lead connecting portions are respectively attached to a cathode and an anode lead connecting plates by a pressing process, a cathode and an anode terminal are attached to the cathode and anode lead connecting portions by a welding process, a soldering process, a blazing process, etc.

In the soldering process, the cathode and anode terminals are combined with the cathode and anode lead connecting portions using filter metal at a temperature of below about 450° C. In the welding and the blazing processes, the cathode and anode terminals are combined with the cathode and anode lead connecting portions at a temperature of above about 450° C. Particularly, the welding process is performed at a temperature of above a melting point of base material (the cathode and anode terminals and the cathode and anode lead connecting portions). However, the blazing process is performed at a temperature of below the melting point of the base material. In the blazing process, filter metal is used to combine the cathode and anode terminals with the cathode and anode lead connecting portions (base material) at a temperature of below the melting point of the base material so that the base material may not be damaged. The terminal plate is prepared considering a sealing process for sealing the terminal plate and a container, and a combining process for combining the cathode and anode lead connecting plates with the rolling up electrode body.

In step 30, the terminal plate is combined to the rolling up electrode body. Cathode and anode lead connecting portions of the terminal plate are attached to cathode and anode leads of the rolling up electrode body in step S40.

As described above, when the terminal plate and the container are sealed using an elastic ring, the terminal plate may include the cathode and anode lead connecting plates that are integrally combined using an insulation combining member such as resin. When the terminal plate and the container are thermally combined by a resin molding process, thermoplastic resin may be used to seal the terminal plate and the container. When the terminal plate and the container are sealed by a seaming process or a welding process, the terminal plate may additionally include a sealing plate of metal and an insulation combining member. Here, upper and bottom faces of the cathode and anode lead connecting portions are exposed or only the bottom faces of the cathode and anode lead connecting portions are exposed according to a combining process for combining the cathode and anode leads of the rolling up electrode body with the cathode and anode lead connecting portions of the cathode and anode lead connecting plates.

When the cathode and anode lead connecting portions are attached to the cathode and anode leads using conductive glue, the cathode and anode leads are coated with the conductive glue and the rolling up electrode body is inserted into the container. The terminal plate and the container are then sealed using a welding process, a seaming process or a sealing member such as an elastic ring while the cathode and anode lead connecting portions are closely contacted with the cathode and anode leads. Then, the conductive glue is dried. When the cathode and anode lead connecting portions are combined with the cathode and anode leads by a welding process, after the rolling up electrode body is inserted into the container, the terminal plate and the container are sealed using a welding process, a seaming process or a sealing member while the cathode and anode lead connecting portions are closely contacted with the cathode and anode leads. Then, laser is irradiated onto the cathode and anode lead connecting portions so as to combine the cathode and anode lead connecting portions with the cathode and anode leads.

When the electric energy storage device includes an electrolyte, the electrolyte is injected into a container after the rolling up electrode and the terminal plate are inserted into the container. Then, the container and the terminal plate are sealed to complete the electric energy storage device. The electric energy storage device of the present invention may include a film type condenser, an electrolytic condenser, an ultra-capacitor, a secondary battery, etc.

In accordance with the above-described method of manufacturing the electric energy storage device, because the cathode and anode terminals are extended from one side of the electric energy storage device, the electric energy storage device may have advantageous utility. Additionally, the electric energy storage device may be easily employed in various electric or electronic apparatuses in order to provide the electric or electronic apparatuses with electric energy.

According to the present invention, an electric energy storage device may have low resistance and also more than two electric energy storage devices may be easily connected in serial or parallel because cathode and anode terminals thereof are extended from one side of the electric energy storage device. Additionally, the electric energy storage device may be simple to be manufactured because the cathode and anode terminals are separately disposed from one end portion of a rolling up electrode body of the electric energy storage device. Thus, productivity of a manufacturing process for the electric energy storage device may be improved.

Having thus described exemplary embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. An electric energy storage device comprising:
a cylindrical rolling up electrode body including a cathode, a separator, an anode, a winding spool, a plurality of cathode leads formed by cathode collectors and a plurality of anode leads formed by anode collectors, wherein the cathode, the separator and the anode are sequentially wound around the winding spool, and the cathode leads and the anode leads are separately extended from one side of the rolling up electrode body;
a terminal plate including a cathode lead connecting plate having a cathode terminal and a cathode lead connecting portion closely contacted with the cathode leads, an anode lead connecting plate having an anode terminal and an anode lead connecting portion closely contacted with the anode leads, and an insulation combing member for integrally combining the cathode lead connecting plate with the anode lead connecting plate wherein the cathode lead connecting plate is electrically insulated from the anode lead connecting plate; and
a container for receiving the rolling up electrode body.

2. The electric energy storage device of claim 1, wherein the cathode lead and the cathode lead connecting portion are combined by a laser welding process, and the anode lead and the anode lead connecting portion are combined by a laser welding process.

3. The electric energy storage device of claim 1, wherein the cathode lead connecting plate and the cathode terminal are combined by a welding process, a soldering process or a blazing process, and the anode lead connecting plate and the anode terminal are combined by a welding process, a soldering process or a blazing process.

4. The electric energy storage device of claim 1, wherein the cathode lead connecting plate and the cathode collectors comprise substantially identical material, and the anode lead connecting plate and the anode collectors comprise substantially identical material.

5. The electric energy storage device of claim 1, wherein the cathode lead connecting plate and the anode lead connecting plate comprise aluminum.

6. The electric energy storage device of claim 1, wherein the insulation combing member comprises any one selected from the group consisting of polyethylene, polypropylene, polyphenylene sulfide, polyether ether ketone and polytetrafluoro ethylene.

7. The electric energy storage device of claim 1, wherein the container comprises any one selected from the group consisting aluminum, stainless steel and tin-plated steel.

8. The electric energy storage device of claim 1, wherein the container comprises any one selected from the group consisting of polyethylene, polypropylene, polyphenylene sulfide, polyether ether ketone and polytetrafluoro ethylene.

9. The electric energy storage device of claim 1, wherein the terminal plate and the container are sealed using an elastic ring.

10. The electric energy storage device of claim 1, wherein the terminal plate further comprises a sealing plate having a cathode lead connecting portion receiving hole for receiving the cathode lead connecting portion of the cathode lead connecting plate, and an anode lead connecting portion receiving hole for receiving the anode lead connecting portion of the anode lead connecting plate, wherein the sealing plate is combined with the cathode lead connecting plate and the anode lead connecting plate, and the terminal plate and the container are sealed by a seaming process or a welding process.

11. The electric energy storage device of claim 10, wherein the sealing plate comprises any one selected from the group consisting aluminum, stainless steel and tin-plated steel.

12. The electric energy storage device of claim 1, wherein the insulation combing member comprises thermoplastic resin, the container comprises a material substantially identical to that of the insulation combing member, and the terminal plate and the container are combined by partially melting the insulation combing member and the container.

13. The electric energy storage device of claim 1, wherein the cathode lead and the cathode lead connecting portion are combined using a conductive glue, and the anode lead and the cathode lead connecting portion are combined using a conductive glue.

14. The electric energy storage device of claim 1, wherein the terminal plate further comprises a sealing plate having a cathode lead receiving hole for receiving the cathode lead of the cathode lead connecting plate, and an anode lead receiving hole for receiving the anode lead of the anode lead connecting plate, wherein the sealing plate is combined with the cathode lead connecting plate and the anode lead connecting plate, and the terminal plate and the container are sealed by a seaming process or a welding process.

15. The electric energy storage device of claim 14, wherein the sealing plate comprises any one selected from the group consisting aluminum, stainless steel and tin-plated steel.

16. The electric energy storage device of claim 1, wherein the terminal plate further comprises an inner pressure control valve.

17. The electric energy storage device of claim 1, the container has a cylindrical structure.

18. A method of manufacturing an electric energy storage device comprising:
forming a rolling up electrode body by winding a cathode, a separator and an anode and by partially cutting the cathode and the anode so that cathode leads and anode leads are separately extended from one side of the rolling up electrode body;
forming a terminal plate including a cathode lead connecting plate having a cathode terminal and a cathode lead connecting portion, and an anode lead connecting plate having an anode terminal and an anode lead connecting portion wherein the cathode lead connecting plate is electrically insulated from the anode lead connecting plate;
inserting the rolling up electrode body into a container;
sealing the terminal plate and the container while the cathode and the anode lead connecting portions are closely contacted with the cathode and the anode leads, respectively;
combining the cathode and the anode lead connecting portions with the cathode and the anode leads, respectively.

19. The method of manufacturing an electric energy storage device of claim 18, wherein the cathode lead connecting portion is combined with the cathode lead by a laser welding process and the anode lead connecting portion is combined with to the anode lead by a laser welding process.

20. The method of manufacturing an electric energy storage device of claim 18, wherein the cathode lead connecting portion is combined with the cathode lead using a conductive glue and the anode lead connecting portion is combined with the anode lead using a conductive glue.

21. The method of manufacturing an electric energy storage device of claim 18, wherein the cathode terminal is combined with the cathode lead connecting plate by a welding process, a soldering process, or a blazing process, and the anode terminal is combined with the anode lead connecting plate by a welding process, a soldering process or a blazing process.

22. The method of manufacturing an electric energy storage device of claim 18, wherein the terminal plate and the container are sealed using an elastic ring.

23. The method of manufacturing an electric energy storage device of claim 18, wherein the terminal plate further comprises a sealing plate having a cathode lead connecting portion receiving hole for receiving the cathode lead connecting portion of the cathode lead connecting plate, and an anode lead connecting portion receiving hole for receiving the anode lead connecting portion of the anode lead connecting plate, wherein the sealing plate is combined with the cathode lead connecting plate and the anode lead connecting plate, and the terminal plate and the container are sealed by a seaming process or a welding process.

24. The method of manufacturing an electric energy storage device of claim 18, wherein the terminal plate further comprises a sealing plate having a cathode terminal receiving hole for receiving the cathode terminal of the cathode lead connecting plate, and an anode terminal receiving hole for receiving the anode terminal of the anode lead connecting plate, wherein the sealing plate is combined with the cathode lead connecting plate and the anode lead connecting plate, and the terminal plate and the container are sealed by a seaming process or a welding process.
